(19) United States
(12) Patent Application Publication
(10) Pub. No.: US 2007/0251357 A1
(43) Pub. Date: Nov. 1, 2007

(54) Three-dimensional angle-adjusted hand tool

(76) Inventor: Chih-Ching Hsieh, Taichung City (TW)

Correspondence Address: CHIH-CHING HSIEH, 235 Chung-Ho, Box 8-24, Taipei, TW

(21) Appl. No.: 11/410,868

(22) Filed: Apr. 26, 2006

(51) Int. Cl. B25B 23/16; B25G 1/00

(52) U.S. Cl. 81/177.9; 81/177.7; 81/177.8

(57) ABSTRACT

A three-dimensional angle-adjusted hand tool comprises a handle; a pivotal portion; and a driving portion. A pivotal structure is installed between the driving portion and the pivotal portion and a rotating structure is installed between the handle and the pivotal portion. Or the pivotal structure is installed between the pivotal portion and the handle and the rotation structure is installed between the pivotal portion and the driving portion. By the pivotal structure and the rotation structure, the orientation of the hand tool can be adjusted three-dimensionally. Furthermore, it is possible that each of two ends of the handle has a pivotal portion and a driving portion.

### FIELD OF THE INVENTION

The present invention relates to hand tools, and particularly to a three-dimensional angle-adjusted hand tool, wherein the driving portion of the hand tool can be rotated with respect to the handle three-dimensionally. Moreover, the driving portion can rotate with respect to the handle through 360 degrees. Thus, the hand tool can be used in many different working places to increase the working efficiency.

### BACKGROUND OF THE INVENTION

The hand tool, such as a spanner, is popular in current lift. There are more and more mechanic devices being used. Thus people needs to use hand tool to assembly or repair these device.

In the prior art, the hand tool has a driving portion and a handle. The driving portion and the handle are fixed. Thus, the driving portion is non-rotatable with respect to the handle. As a result, it is often that the operation of the hand tool is inconvenient as the working place is not suitable for locating the hand tool

There are some improvements for improving the above mentioned difficult, such as those disclosed in U.S. patents with U.S. Pat. Nos. 5,419,221, and 6,928,904. In these prior art, a pivotal structure is installed between the driving portion and the handle so that the driving portion is rotatable with respect to the handle.

However all of these prior arts have complicated structures. Moreover, the hand tools are easy to slide out from a screwing object. Thereby the pivotal portions are thicker than other prior arts of the hand tool so that the hand tool cannot be used easily in many working place. Thereby in these prior arts, the driving portion is only rotatable at one surface. Thus it is a two dimensional adjustment. However it cannot make a three dimensional adjustment.

Thus, as a whole, the hand tool still has some defects which make the hand tool cannot be used in many working places.

### SUMMARY OF THE INVENTION

Accordingly, the primary object of the present invention is to provide a three-dimensional angle-adjusted hand tool, wherein the driving portion of the hand tool can be rotated with respect to the handle three-dimensionally. Moreover, the driving portion can rotate with respect to the handle through 360 degrees. Thus, the hand tool can be used in many different working places to increase the working efficiency.

To achieve above objects, the present invention provides a three-dimensional angle-adjusted hand tool which comprises handle; a pivotal portion; and a driving portion. A pivotal structure is installed between the driving portion and the pivotal portion and a rotating structure is installed between the handle and the pivotal portion. Or the pivotal structure is installed between the pivotal portion and the handle and the rotation structure is installed between the pivotal portion and the driving portion. By the pivotal structure and the rotation structure, the orientation of the hand tool can be adjusted three-dimensionally. Furthermore, it is possible that each of two ends of the handle has a pivotal portion and a driving portion.

The various objects and advantages of the present invention will be more readily understood from the following detailed description when read in conjunction with the appended drawing.

### BRIEF DESCRIPTION OF THE DRAWINGS

FIG. 1 is an exploded perspective view of the three-dimensional angle-adjusted hand tool of the present invention.

FIG. 2 is a perspective view of the three-dimensional angle-adjusted hand tool of the present invention.

FIG. 3 is an elevational view of the three-dimensional angle-adjusted hand tool of the present invention.

FIG. 4 is a partial elevational view of the three-dimensional angle-adjusted hand tool of the present invention.

FIG. 5 is a partial cross sectional view of the three-dimensional angle-adjusted hand tool of the present invention.

FIG. 6 is a schematic view showing the transversal angle adjustment of the three-dimensional angle-adjusted hand tool of the present invention.

FIG. 7 is a schematic view showing the longitudinally angle adjustment of the three-dimensional angle-adjusted hand tool of the present invention.

FIGS. 8 and 9 are schematic views showing the use of the three-dimensional angle-adjusted hand tool of the present invention.

FIG. 10 is an exploded view of the second embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

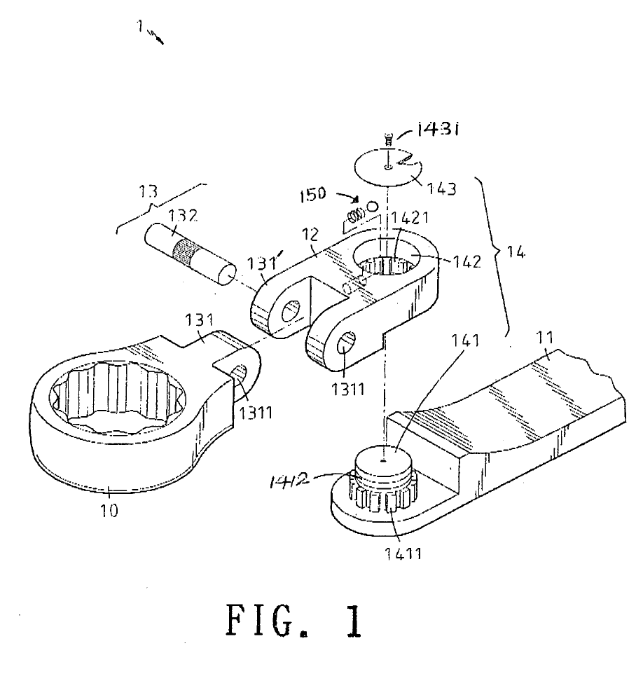

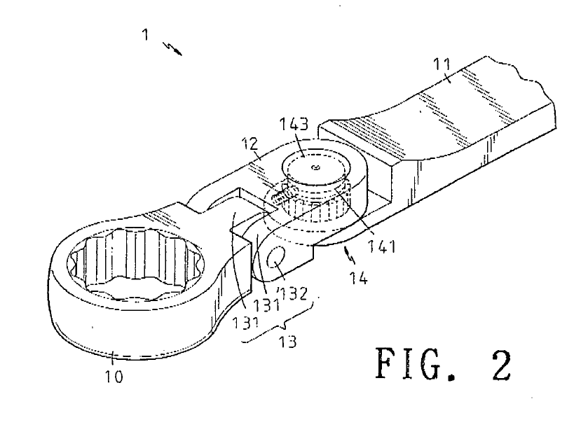

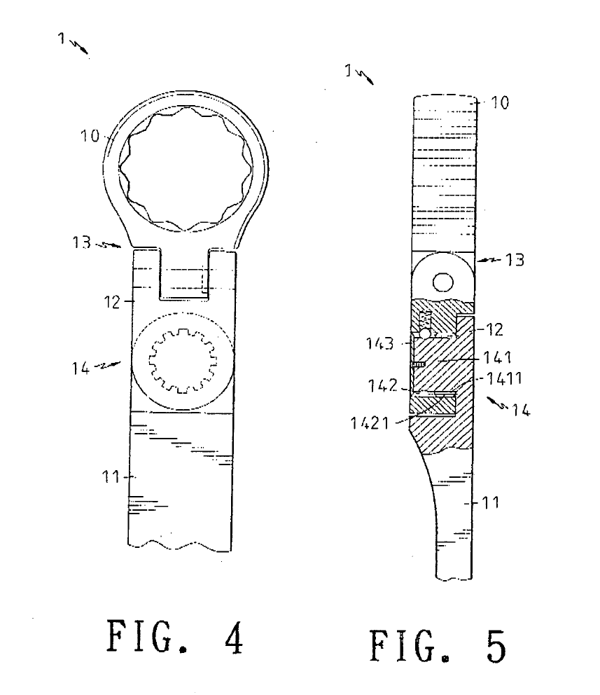

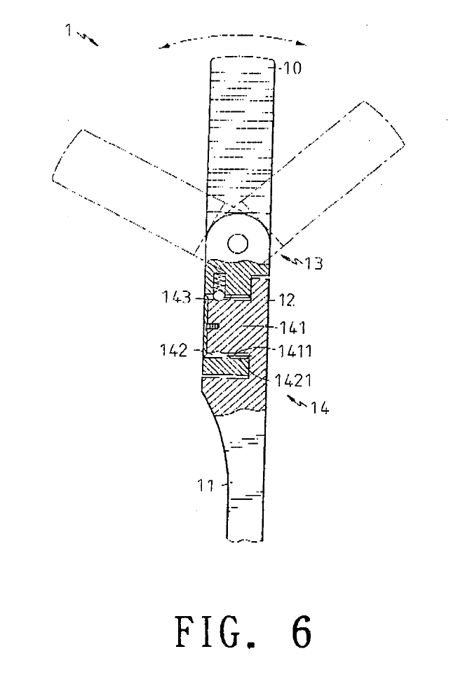

Referring to FIGS. 1 to 5, the three dimensional angle adjustment hand tool of the present invention is illustrated. The spanner body 1 includes a driving portion 10, a handle 11 and a pivotal portion 12 which is interacted with the driving portion 10 and the handle 11. The driving portion 10 may has a form of opened spanner, or a ring spanner or a ratchet spanner, etc. In the following, the ring spanner is used as an example.

The driving portion 10 serves for engaging with a screwing device. The handle 11 can be held by a user. Two ends of the pivotal portion 12 are connected to the driving portion 10 and the handle 11. An adjusting structure 13 is installed between the pivotal portion 12 and the driving portion 10 for adjusting the orientation of the driving portion 10 longitudinally with respect to the pivotal portion 12.

In the adjusting structure 13, the driving portion 10 has a pivotal block 131 with an axial hole 1311. The pivotal portion 12 has two pivotal blocks 131′. Each pivotal block 131′ has an axial hole 1311′. A shaft 132 passes through the axial hole 1311 of the driving portion 10 and the axial holes 1311′ of the pivotal portion 12 so as to pivotally install the driving portion 10 to the pivotal portion 12.

A rotating structure 14 includes a position portion. In the rotating structure 14, one end of the handle 11 is formed with an engaging block 141 and one end of the pivotal portion 12 is formed with an engaging hole 142. A part of an outer periphery of the engaging block 141 is formed with a teeth portion 1411 and a part of an inner periphery of the engaging hole 142 is formed with an annular rack 1421 which is engageable with the teeth portion 1411. The engaging block 141 is engaged to the engaging hole 142. Then a cover 143 serves for covering the engaging block 141 in the engaging hole 142. When the pivotal portion 12 is lifted slightly from the handle 11, the engaging block 141 is disengaged from the engaging hole 142. Then the pivotal portion 12 is rotatable with respect to the handle 11 along the engaging block 141. If the pivotal portion 12 is descended, the engaging block 141 will engage to the engaging hole 142. Thus, the engaging block 141 is fixed to the engaging hole 142.

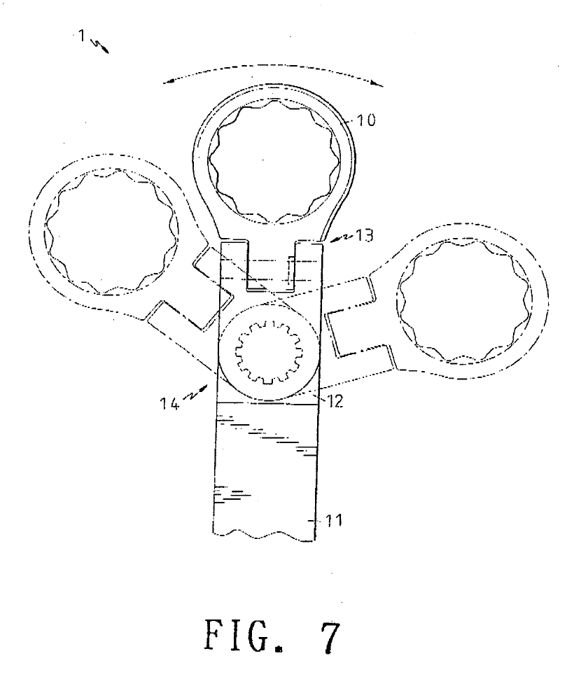

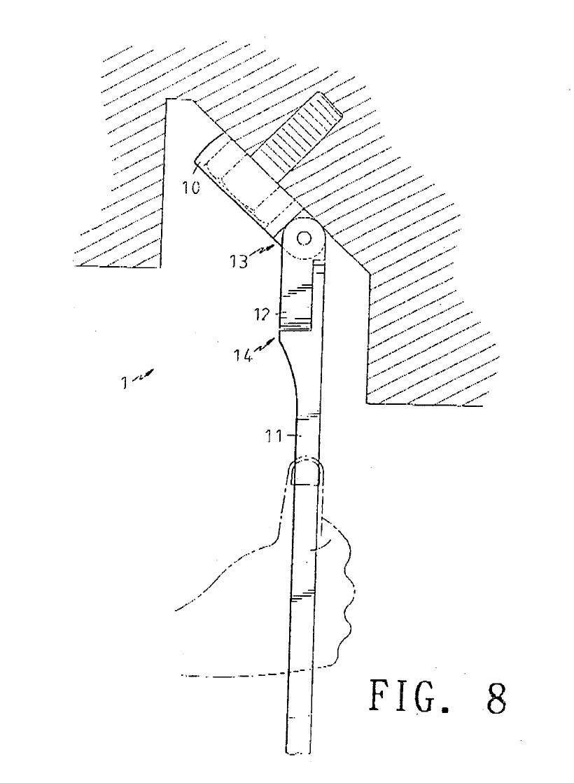

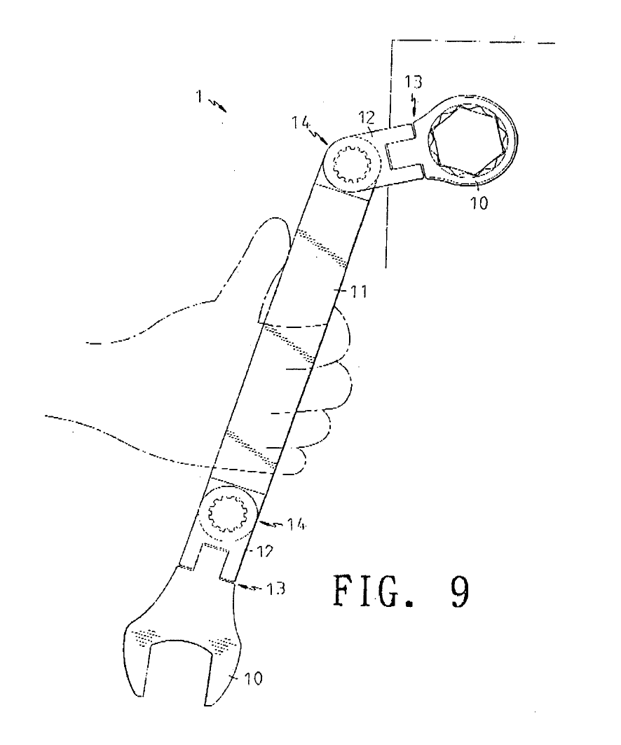

Referring to FIG. 6 to 9, it shows that the present invention can be adjusted horizontally by rotating the pivotal portion 12 with respect to the rotating structure 14 through the rotation of the engaging block 141. Moreover, the present invention can be adjusted longitudinally by pivotally rotating the driving portion 10 with respect to the pivotal portion 12 through the rotation of the adjusting structure 13.

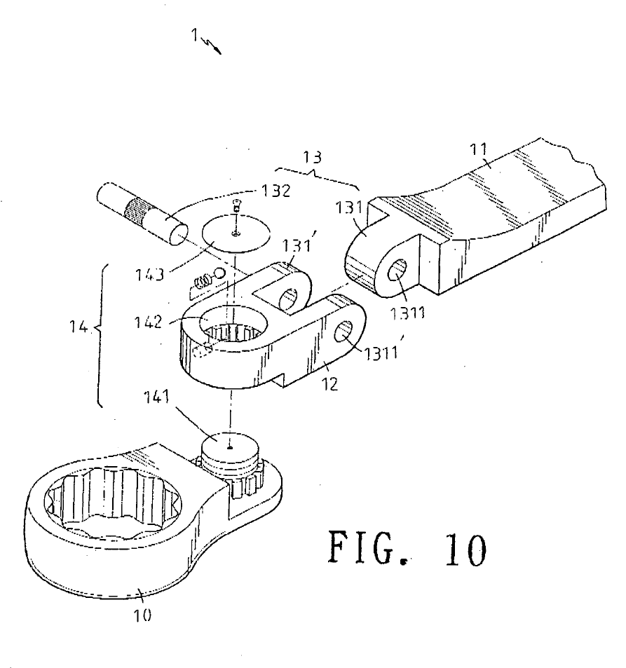

Referring to FIG. 10, the second the present invention of the present invention is illustrated. Those identical to the above mentioned embodiment will not be described herein. Only those different are described.

In the second embodiment, the adjusting structure 13 is installed between the pivotal portion 12 and the handle 11. The rotating structure 14 is installed between the driving portion 10 and the pivotal portion 12. This arrangement still achieves the effect the first embodiment.

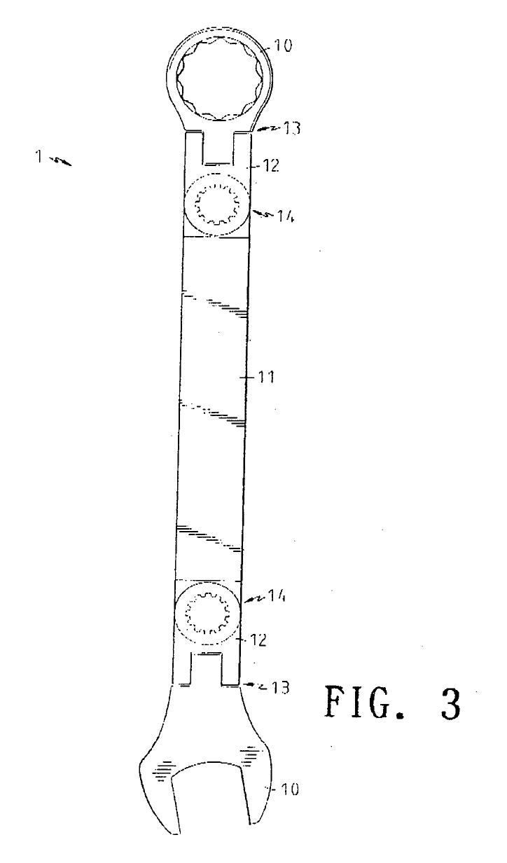

Furthermore, referring to FIG. 3, in the present invention, each of the two ends of the spanner body 1 can be installed with respective driving portion 10 and respective pivotal portion 12.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1-10. (canceled)

11. A three-dimensional angle-adjusted hand tool comprising:
a three-dimensional angle-adjusted hand tool comprising: a driving portion, a handle and a pivotal portion interacted with the driving portion and the handle.
the driving portion serving for engaging with a screwing device; two ends of the pivotal portion being connected to the driving portion and the handle; an adjusting structure being installed between the pivotal portion and the driving portion for adjusting the orientation of the driving portion longitudinally with respect to the pivotal portion;
the driving portion having a pivotal block with an axial hole; the pivotal portion having two pivotal blocks; each pivotal block having an axial hole; a shaft passes through the axial hole of the driving portion and the axial holes of the pivotal portion so as to pivotally install the driving portion to the pivotal portion;
one end or the handle being formed with an engaging block and one end of the pivotal portion being formed with an engaging hole; a part of an outer periphery of the engaging block being formed with a teeth portion and a part of an inner periphery of the engaging hole being formed with an annular rack which is engageable with the teeth portion; the engaging block being engaged to the engaging hole; then a cover serves for covering the engaging block in the engaging hole; wherein the engaging portion having the teeth portion at a lower side and a recess at an upper side; and the teeth of the teeth portion being axially arranged; and a stud passing through a hole at a central area of the cover and a hole in a top of the engaging block so as to lock the cover to the engaging block;
a lateral inner wall of the engaging hole having a hole for receiving an elastic unit which is formed by a spring and a ball; the engaging unit resisting against the recess at an upper side of the engaging block;
wherein when the pivotal portion is lifted slightly from the handle, the engaging block is disengaged from the engaging hole; then the pivotal portion is rotatable with respect to the handle along the engaging block; if the pivotal portion is descended, the engaging block will engage to the engaging hole; thus, the engaging block is fixed to the engaging hole.

12. The three-dimensional angle-adjusted hand tool as claimed in claim 1, wherein the driving portion has a form selected from an opened spanner, a ring spanner and a ratchet spanner.
